(19) United States
(12) Patent Application Publication
(10) Pub. No.: US 2014/0355610 A1
(43) Pub. Date: Dec. 4, 2014

(54) SWITCHED POWER LINE COMMUNICATION

(71) Applicant: QUALCOMM Incorporated, San Diego, CA (US)

(72) Inventors: Feng GE, Highland Park, NJ (US); Jinder WANG, Dublin, CA (US); Vincent D. PARK, Budd Lake, NJ (US); Junyi LI, Chester, NJ (US)

(21) Appl. No.: 13/907,575

(22) Filed: May 31, 2013

(51) Int. Cl. H04B 3/54; H04L 12/741; H04L 12/931; H04L 12/40

(52) U.S. Cl. CPC H04B 3/542; H04L 12/40; H04L 45/74; H04L 49/40
USPC 370/392; 370/389; 370/419

(57) ABSTRACT

A method, an apparatus, and a computer program product for power line communication (PLC) are provided. The apparatus receives a first packet, selects a bus from a plurality of PLC buses, each PLC bus isolated from other buses of the plurality of buses, and forwards the first packet to a destination PLC modem connected to the selected bus. A method and system for switched power line communication (PLC) is also provided. The system provides power to a plurality of PLC buses via a main circuit breaker, receives a first signal for communicating to a PLC bus, selects a PLC bus from the plurality of buses based on the first signal, communicates a second signal to the selected PLC bus, the second signal based on the first signal, and filters the second signal communicated to the selected PLC bus to prevent the second signal from passing through the main circuit breaker.

### BACKGROUND

1. Field

The present disclosure relates generally to power line communication systems, and more particularly, to a switched power line communication network.

2. Background

Power line communication (PLC) is a technology that encodes data in a signal and transmits the signal on existing electricity power lines in a band of frequencies that are not used for supplying electricity. Accordingly, PLC leverages the ubiquity of existing electricity networks to provide extensive network coverage. Since PLC enables data to be accessed from conventional power-outlets, no new wiring needs to be installed in a building (or different parts of a building). Accordingly, PLC offers the additional advantage of reduced installation costs.

In some dwellings, PLC communications may be the best option for servicing communications, e.g., wireless communications incapable of penetrating walls or other structure, wireless communications deemed too insecure, installing wiring for other communication types is too expensive, etc. In many structures, however, the power mains, which service multiple differing dwellings, offices, etc., are serviced by a common feed, which allows PLC signals to propagate in undesired manners, which can limit the capacity available for PLC communications and to allow PLC signals to propagate to undesired locations and devices.

### SUMMARY

In an aspect of the disclosure, a method, a computer program product, and an apparatus for power line communication (PLC) are provided. The apparatus receives a first packet, selects a bus from a plurality of PLC buses, each PLC bus being isolated from other buses of the plurality of buses, and forwards the first packet to a destination PLC modem connected to the selected bus.

In another aspect, a method and system for switched power line communication (PLC) are provided. The system provides power to a plurality of PLC buses via a main circuit breaker, each PLC bus isolated from other buses of the plurality of buses, receives a first signal for communicating to a PLC bus, selects a PLC bus from the plurality of buses based on the first signal, communicates a second signal to the selected PLC bus, the second signal based on the first signal, and filters the second signal communicated to the selected PLC bus to prevent the second signal from passing through the main circuit breaker.

### BRIEF DESCRIPTION OF THE DRAWINGS

FIG. 1 is a diagram illustrating an exemplary power line communication (PLC) network.

FIG. 2 is a diagram illustrating PLC bus segmentation at an individual circuit breaker level for a PLC communication network.

FIG. 3 is a diagram illustrating segmentation across a number of panels of a PLC communication network.

FIG. 4 is a diagram illustrating a cascaded PLC communication network.

FIG. 5 is a flow chart of a method for switched power line communication.

FIG. 6 is a flow chart of a method of power line communication (PLC).

FIG. 7 is a conceptual data flow diagram illustrating the data flow between different modules/means/components in an exemplary apparatus.

FIG. 8 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of power line communication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

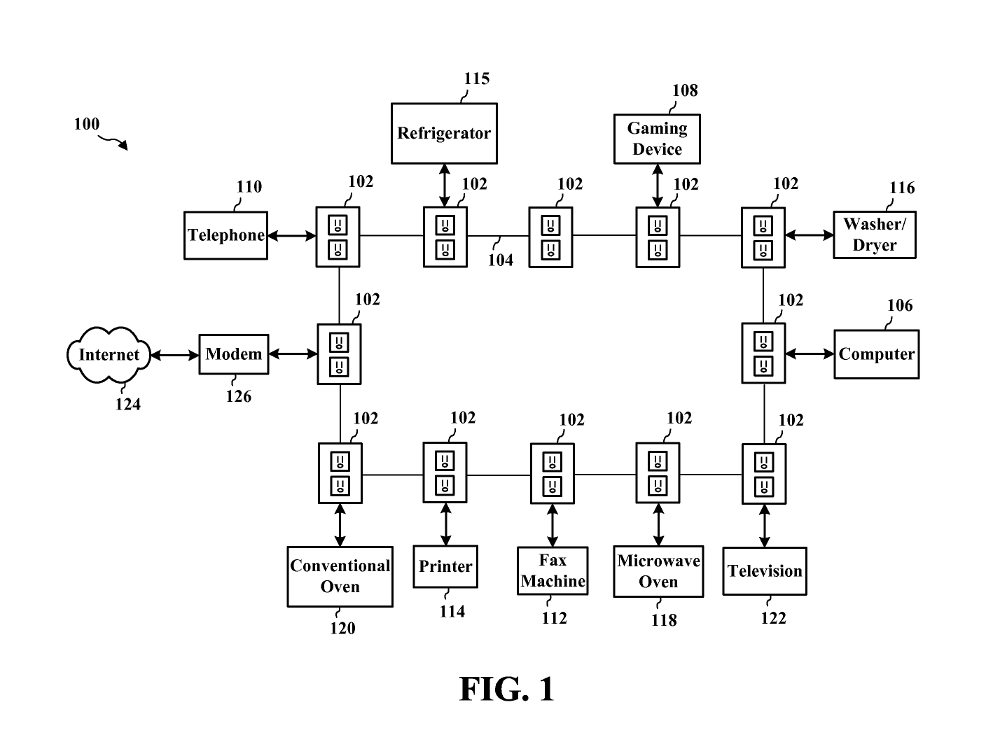

FIG. 1 is a diagram illustrating an exemplary power line communication (PLC) network 100. Referring to FIG. 1, the PLC network 100 comprises a plurality of power line outlets 102 electrically coupled to one another via a power line 104. A number of devices and/or appliances may be coupled to the PLC network via interconnection with the plurality of outlets 102. For example, as shown in FIG. 1, a personal computer 106, a gaming device 108, a telephone 110, a facsimile machine 112, and a printer 114 may be networked together via electrical connection with the power line 104 through their respective and associated power line outlets 102. In addition, “smart” appliances such as a refrigerator 115, a washer/dryer 116, a microwave oven 118, and a conventional oven 120 may also be networked together using the PLC network 100. A smart television 122 may be networked via electrical connection with an associated power line outlet 102. The PLC network 100 may also access the Internet 124 by connecting through a modem 126 or other Internet access device.

Power line wiring may be electrically analogous to a network of transmission lines connected together in a large tree-like configuration. The power line wiring may have differing terminating impedances at the end of each stub of the network. As a consequence, the transfer function of a power line transmission channel may have substantial variations in gain and phase across the frequency band. Further, the transfer function between a first pair of power outlets may differ from that between a second pair of power outlets. The transmission channel can be fairly constant over time. Changes in the channel may occur when electrical devices are plugged into or removed from the power line (or occasionally when the devices are powered on/off). When used for networking devices in a power line communication network, the frequencies used for communication typically are well above the 60-cycle AC power line frequency. Therefore, a desired communication signal spectrum may be separated from a real power-bearing signal in a receiver connected to the power line network.

Another consideration in the power line environment is noise and interference. Many electrical devices create large amounts of noise on the power lines. Therefore, it is preferable that a power line networking system be capable of tolerating the noise and interference present on the power lines. The power line interference may be frequency selective. Frequency selective interference causes interference at specific frequencies (e.g., signals operating at specific frequencies may be interfered while other signals may experience no interference). The power line interference may also be impulsive by nature. Impulsive interference may span a broad range of frequencies but occurs in short time bursts. Some power line interference may be a hybrid of frequency selective interference and impulsive interference.

Noise may be neither uniform nor symmetrical across the power lines. For example, noise proximate a first device may cause the first device to be unable to receive data from a more distant second device. However, the second device may be able to receive data from the first device. The second device may be able to receive information from the first device because the noise at the receiver of the second device may be attenuated as much as is the desired signal. However, because the noise at the receiver of the first device is not as attenuated as is the desired signal (because the noise source is much closer to the first device than the second device), the first device will be unable to receive information from the second device.

A Power Line Communication (PLC) network may be bus-structured with a number of taps to which PLC modems may be connected. A switched PLC network splits a larger collision domain into smaller domains through PLC signal isolation using low-pass filters to permit simultaneous PLC signal transmissions in the smaller domains. This reduces a collision probability and improves overall throughput. A number of circuit breakers through which a PLC signal has to travel is also reduced. Circuit breakers significantly attenuate PLC signals. Therefore, by reducing the number of circuit breakers through which the PLC signal has to travel, the adverse effects of signal attenuation caused by the circuit breakers is minimized.

Splitting a large PLC collision domain into smaller domains may be referred to as segmentation. Network segments (e.g., PLC buses) may be connected through a switch such as an Ethernet switch (or PLC gateways). In case of using an Ethernet switch, a PLC modem may also include an Ethernet interface.

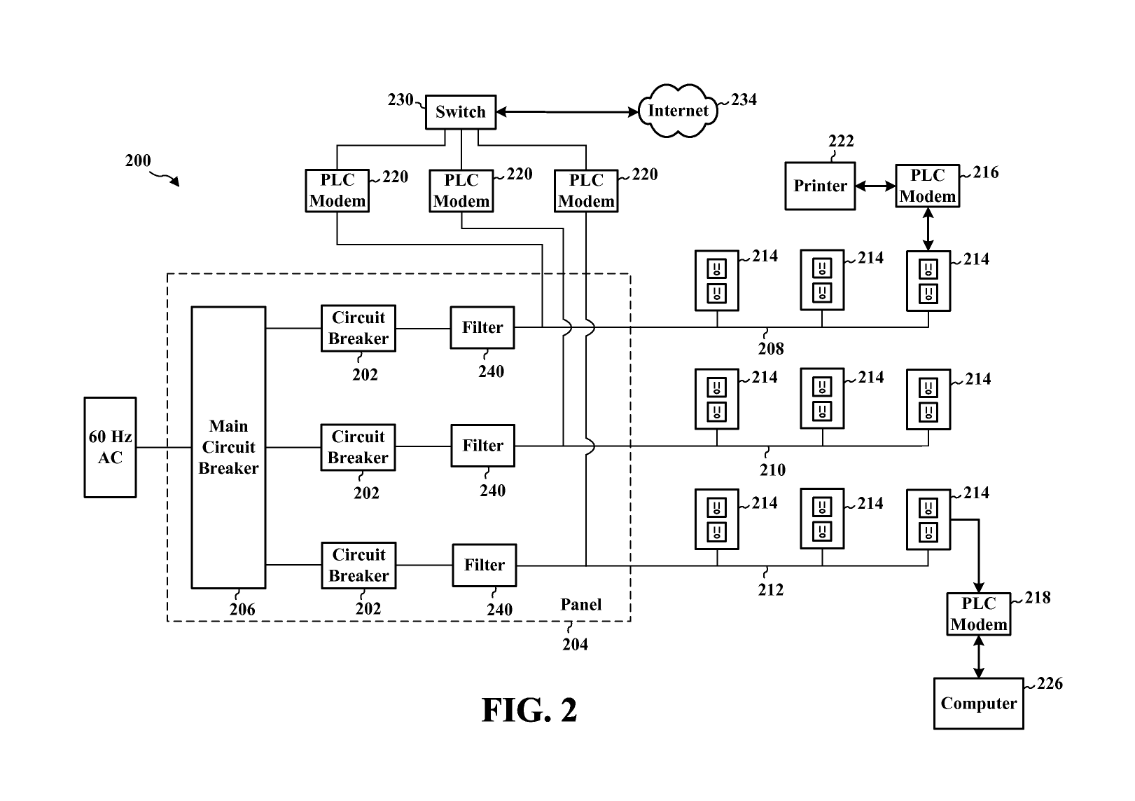

FIG. 2 is a diagram illustrating PLC bus segmentation at an individual circuit breaker level for a PLC communication network 200. In FIG. 2, a number of circuit breakers 202 of a panel 204 are connected in parallel to a main circuit breaker 206. Network segments (e.g., first PLC bus 208, second PLC bus 210, and third PLC bus 212) may contain a bus-structured leg having any number of taps (e.g., electric outlets) 214. Although only three PLC buses are shown in FIG. 2, the PLC communication network 200 may include any number of PLC buses. The number of PLC buses may be isolated from each other with respect to PLC communication. However, the number of PLC buses may not be isolated from each other with respect to power distribution. For example, the first PLC bus 208, the second PLC bus 210, and the third PLC bus 212 are all connected to the same main circuit breaker 206. Each PLC bus (208, 210, and 212) may have an end connected to a respective circuit breaker 202 of the panel 204. A PLC modem may be plugged into any one of the number of electric outlets 214 of a PLC bus. For example, as shown in FIG. 2, a PLC modem 216 may be plugged into an electric outlet 214 on the first PLC bus 208. In another example, a PLC modem 218 may be plugged into an electric outlet 214 on the third PLC bus 212. A PLC modem plugged into an electric outlet may be utilized by a device for communicating with other devices connected to the network 200. For example, a printer 222 may be connected to the PLC modem 216 of the first PLC bus 208 for communicating with other network devices. In another example, a computer 226 may be connected to the PLC modem 218 of the third PLC bus 212 for communicating with other network devices.

Referring to FIG. 2, a number of PLC modems 220 having a respective Ethernet interface may be connected to a switch 230 at one end. Another end of each of the PLC modems 220 may be connected to a respective end of a PLC bus connected to a respective circuit breaker 202. Accordingly, a PLC modem (e.g., PLC modem 216 or PLC modem 218) plugged into an electric outlet of one PLC bus may communicate with (e.g., send PLC signals to) another PLC modem of another PLC bus via the switch 230, wherein the switch 230 utilizes one or more of the PLC modems 220 connected thereto. For example, the PLC modem 216 plugged into an electric outlet 214 of the first PLC bus 208 may send PLC signals to the PLC modem 218 plugged into an electric outlet of the third PLC bus 212 via the switch 230 (using one or more of the PLC modems 220). The switch 230 may also send and receive information to and from the Internet 234.

In the PLC network 200, a PLC signal sent from a PLC modem (e.g., PLC modem 216 or PLC modem 218) to the switch 230, or sent from the switch 230 to the PLC modem (e.g., PLC modem 216 or PLC modem 218), does not travel through any of the circuit breakers 202, thus minimizing signal attenuation. The PLC signal may be prevented from traveling through a circuit breaker 202 by filtering the PLC signal using a filter 240 prior to reaching the circuit breaker 202. For example, if a circuit breaker 202 normally operates at 60 Hz AC, then a filter 240 isolating signals above 60 Hz may be used to prevent the PLC signal from passing through the circuit breaker 202.

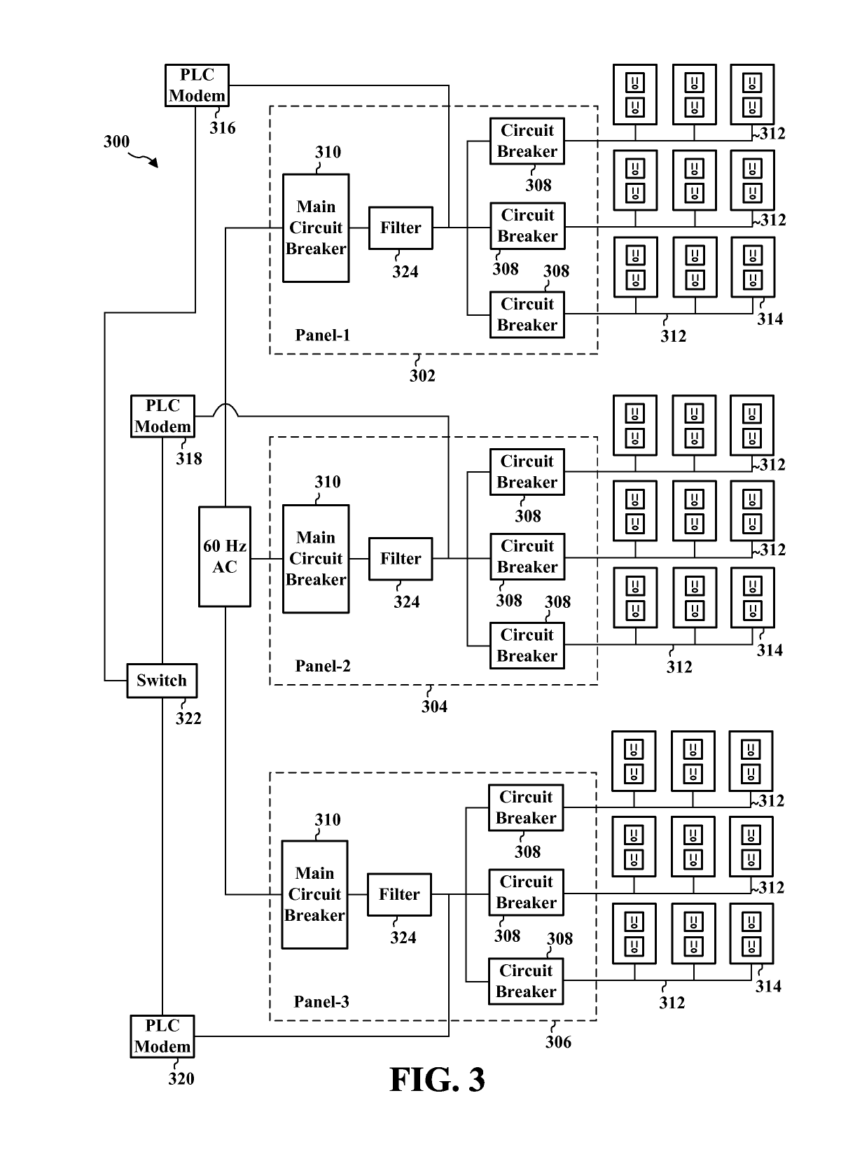

FIG. 3 is a diagram illustrating segmentation across a number of panels of a PLC communication network 300. Multiple panels (e.g., panel-1 302, panel-2 304, and panel-3 306) may be used in an office environment, for example. Although only three panels are shown in FIG. 3, the PLC communication network 300 may include any number of panels. Each panel contains a number of individual circuit breakers 308 connected in parallel to a main circuit breaker 310. Each individual circuit breaker 308 may be connected to a bus-structured leg (PLC bus) 312 having a number of taps (electric outlets) 314. A PLC modem may be plugged into any one of the number of electric outlets 314 of a PLC bus (as discussed with respect to FIG. 2). A PLC modem plugged into an electric outlet may be utilized by a device for communicating with other devices connected to the network 300.

In an aspect, the multiple panels of the PLC communication network 300 may be segmented at an individual circuit breaker level (as discussed with respect to FIG. 2). However, doing so may be overly complicated or costly when multiple panels are involved. Accordingly, to lessen complexity, network segmentation may occur across the multiple panels at a main circuit breaker level.

In an aspect, a network segment may contain a number of legs (e.g., PLC buses). The number of PLC buses may be isolated from each other with respect to PLC communication. However, the number of PLC buses may not be isolated from each other with respect to power distribution. For example, the number of PLC buses 312 may be connected to a same main circuit breaker 310. Communication between any devices within a panel may travel across two circuit breakers 308. Moreover, communication between any devices of two different panels may also travel across two circuit breakers 308. The communication may be performed by conveying a message or data packet. Signaling used to convey the message or data packet may vary. For some segments of the communication path, the signaling may be PLC signaling. For other segments of the communication path, the signaling may be some other type of data signaling (e.g., Ethernet signaling). For example, a message or data packet sent from a PLC bus 312 connected to the panel-1 302 may travel across a circuit breaker 308 of the panel-1 302 to a PLC modem 316 connected to a switch 322. The switch 322 may then send the message or data packet to either a PLC modem 318 or a PLC modem 320 depending on which PLC bus the PLC signal is destined for. Accordingly, if the message or data packet is destined for a PLC bus 312 connected to the panel-2 304, the switch 322 will send the message or data packet to the PLC modem 318 for forwarding across a circuit breaker 308 of the panel-2 304 to the appropriate PLC bus 312 connected to the panel-2 304. If the message or data packet is destined for a PLC bus 312 connected to the panel-3 306, the switch 322 will send the message or data packet to the PLC modem 320 for forwarding across a circuit breaker 308 of the panel-3 306 to the appropriate PLC bus 312 connected to the panel-3 306.

Still referring to FIG. 3, a message or data packet sent from a PLC bus 312 to the switch 322, or sent from the switch 322 to the PLC bus 312 does not travel through any of the main circuit breakers 310, thus minimizing signal attenuation. The message or data packet may be prevented from traveling through a main circuit breaker 310 by filtering the message or data packet using a filter 324 prior to reaching the main circuit breaker 310. For example, if a main circuit breaker 310 normally operates at 60 Hz AC, then a filter 324 isolating signals above 60 Hz may be used to prevent the message or data packet from passing through the main circuit breaker 310.

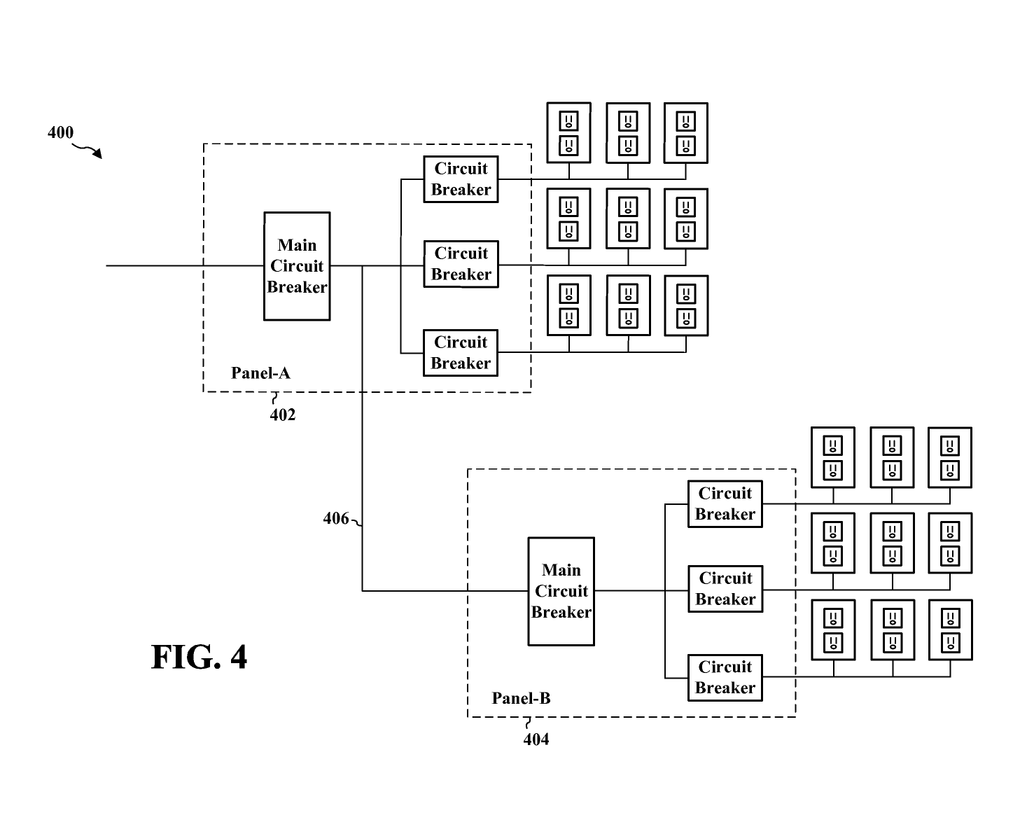

FIG. 4 is a diagram illustrating a cascaded PLC communication network 400. Referring to FIG. 4, the network 400 includes two panels (e.g., panel-A 402 and panel-B 404) in a tandem configuration, which may be a typical layout in many homes. The two panels may be located in different parts of a building, for example. Segmentation of the network 400 may be performed either at an individual circuit breaker level or a main circuit breaker level, as shown in FIGS. 2 and 3, respectively.

Different switching architectures may also be applied. Because the panel-A 402 is separated from the panel-B 404, either a new Ethernet cable may be installed or a power wire 406 used to connect the two panels may be used for switching. The two panels may be segmented using filters. For example, referring to FIG. 4, a filter may be provided between the main circuit breaker and the plurality of circuit breakers of panel-A 402. Similarly, a filter may also be provided between the main circuit breaker and the plurality of circuit breakers of panel-B 404. One or more filters may also be provided on the power wire 406 between the main circuit breaker of panel-B 404 and an endpoint of the power wire 406 at panel-A 402, the endpoint flanked by the main circuit breaker and the plurality of circuit breakers of panel-A 402. In FIG. 4, as a result of segmenting each of the panels, the power wire 406 connecting the panel-A 402 to the panel-B 404 may be isolated from the PLC signals of the two panels.

In an aspect, two PLC modems may be respectively attached to each end of the power wire 406 in conjunction with any of the filters described above. The Ethernet interfaces of the two PLC modems may be each connected to either an Ethernet interface of a switch port or that of a PLC modem, depending on a switching architecture used. Although FIG. 4 shows two panels in tandem, use of the panel connecting power wire 406 for switching is not limited to the case of two panels in tandem. Specifically, the same concept may apply to parallel panels.

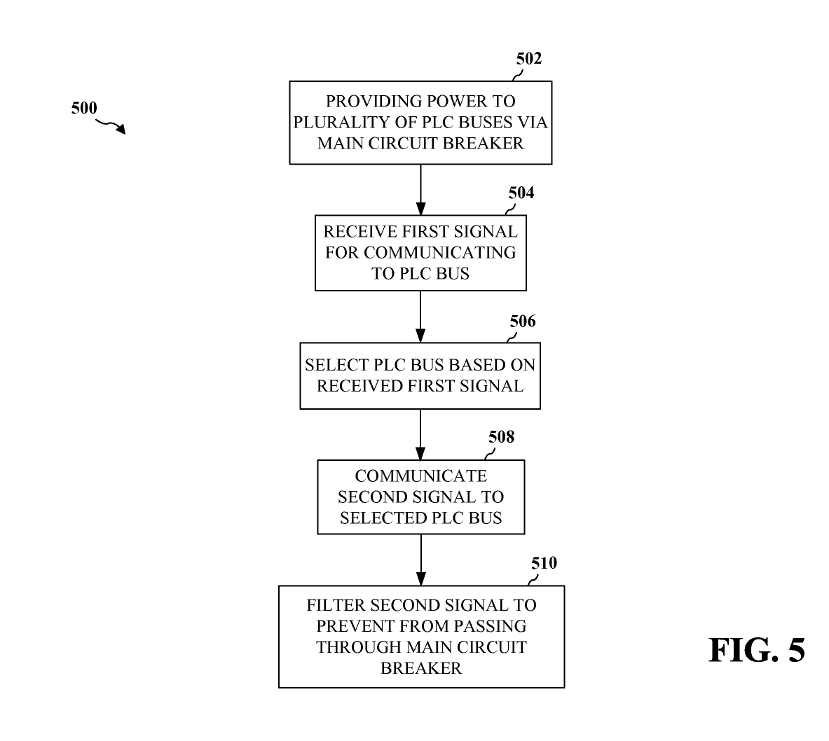

FIG. 5 is a flow chart 500 of a method for switched power line communication (PLC). The method may be performed by a system or network (e.g., PLC communication network 200 of FIG. 2).

At step 502, the system provides power to a plurality of PLC buses via a main circuit breaker. Each PLC bus may be isolated from other buses of the plurality of buses. In an aspect, the plurality of PLC buses may be isolated from each other with respect to PLC communication. However, the plurality of PLC buses may not be isolated from each other with respect to power distribution. For example, the plurality of PLC buses may be connected to a same main circuit breaker. Moreover, each PLC bus may include a plurality of connected PLC modems communicating with each other. A PLC modem may be utilized by a device to communicate with other devices connected to the system.

At step 504, the system receives a first signal for communicating to a PLC bus. The first signal may be received by receiving a message or data packet. Signaling used to receive the message or data packet may vary. For some segments of the communication path, the signaling may be PLC signaling. For other segments of the communication path, the signaling may be some other type of data signaling (e.g., Ethernet signaling). In an aspect, to minimize signal attenuation, the system may filter the first signal to prevent the first signal from passing through the main circuit breaker prior to being further processed by the system. At step 506, the system selects a PLC bus from the plurality of buses based on the first signal. The first signal may be received from the Internet. Alternatively, the first signal may be received from one of the plurality of buses other than the selected bus. The system may select the PLC bus based on an address associated with the first signal. The address may correspond to a destination PLC modem that is one of a plurality of PLC modems connected to the selected bus.

At step 508, the system communicates a second signal to the selected PLC bus. In particular, the system may communicate the second signal to a destination PLC modem connected to the selected bus. The second signal may be communicated via a message or data packet. Signaling used to communicate the message or data packet may vary. For some segments of the communication path, the signaling may be PLC signaling. For other segments of the communication path, the signaling may be some other type of data signaling (e.g., Ethernet signaling). The second signal may be based on the first signal. For example, the second signal may be the same as the received first signal. Hence, the second signal may be a message or data packet communicated via the same type of signaling (e.g., PLC signaling, Ethernet signaling, etc.) used to receive the first signal. Alternatively, the second signal may be a deconstructed or reconstructed version of the received first signal. That is, the first signal may be a first message or data packet received via a first type of signaling (e.g., PLC signaling, Ethernet signaling, etc.) and the second signal may be a second message or data packet generated based on the first message or data packet, but communicated via a second type of signaling (e.g., PLC signaling, Ethernet signaling, etc.) different from the first type of signaling.

At step 510, the system filters the second signal communicated to the selected PLC bus to prevent the second signal from passing through the main circuit breaker. Filtering prevents a signal (e.g., message or data packet) from being provided to a destination bus more than once. For example, a signal may be provided to a destination bus a first time via switching, and provided to the destination bus a second time when an original signal travels through connected power wiring and through circuit breakers on its way to the destination bus of the power wiring. Accordingly, by preventing the second signal from passing through the main circuit breaker, the filtering at step 510 prevents interference and helps ensure that the second signal is provided to the selected PLC bus no more than once.

An example of a hardware implementation for performing each of the steps of the algorithm in the aforementioned flow chart of FIG. 5 may be described with respect to FIG. 2, which illustrates different modules/means/components of an exemplary PLC communication system/network 200.

Referring to FIG. 2, an exemplary switched PLC network includes a plurality of PLC buses 208, 210, and 212. Each PLC bus may be isolated from other buses of the plurality of buses. In an aspect, the plurality of PLC buses may be isolated from each other with respect to PLC communication. However, the plurality of PLC buses may not be isolated from each other with respect to power distribution. Each PLC bus may include a plurality of connected PLC modems (e.g., PLC modem 216 or PLC modem 218) communicating with each other. A PLC modem may be utilized by a device (e.g., printer 222) to communicate with other devices (e.g., computer 226) connected to the network 200. The exemplary network 200 further includes a main circuit breaker 206 for providing power to the plurality of PLC buses 208, 210, and 212.

In an aspect, the exemplary network 200 includes at least one PLC modem (e.g., PLC modem 216) connected to an electric outlet 214 of one of the PLC buses (e.g., PLC bus 208) and at least one other PLC modem (e.g., PLC modem 218) connected to an electric outlet 214 of another one of the PLC buses (e.g., PLC bus 212). Accordingly, the at least one PLC modem (e.g., PLC modem 216) may communicate a signal with the at least one other PLC modem (e.g., PLC modem 218) via a switch 230.

The switch 230 may receive a first signal for communicating to a PLC bus, and select a PLC bus from the plurality of PLC buses 208, 210, and 212 based on the first signal. In an aspect, to minimize signal attenuation, at least one of the plurality of filters 240 may filter the first signal to prevent the first signal from passing through the main circuit breaker 206 prior to being received by the switch 230. A respective filter 240 of the plurality of filters may be connected between a corresponding PLC bus and the main circuit breaker 206. The respective filter 240 may also be connected between the switch 230 and the main circuit breaker 206.

The switch 230 may select the PLC bus based on an address associated with the first signal. The address may correspond to a destination PLC modem (e.g., PLC modem 216) that is one of a plurality of PLC modems connected to the selected bus (e.g., PLC bus 208).

In an aspect, the switch 230 may receive the first signal from the Internet 234. Alternatively, the switch 230 may receive the first signal from one of the plurality of buses other than the selected bus. For example, if the selected bus is the PLC bus 208, then the switch 230 may receive the first signal from the PLC bus 210 or the PCL bus 212.

Upon the switch 230 receiving the first signal and selecting a bus, the switch 230 may communicate a second signal to the selected PLC bus (e.g., PLC bus 208). In particular, the switch 230 may communicate the second signal to a destination PLC modem 216 connected to the selected bus 208. The second signal may be based on the first signal. For example, the second signal may be the same as the received first signal. Alternatively, the second signal may be a deconstructed or reconstructed version of the received first signal. A filter 240 may filter the second signal communicated to the selected PLC bus 208 to prevent the second signal from passing through the main circuit breaker 206.

The network 200 may include additional modules that perform each of the steps of the algorithm in the aforementioned flow chart FIG. 5. As such, each step in the aforementioned flow chart of FIG. 5 may be performed by a module and the network may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

In one configuration, the network 200 for power line communication includes means for providing power to a plurality of PLC buses via a main circuit breaker, each PLC bus isolated from other buses of the plurality of buses, means for receiving a first signal for communicating to a PLC bus, means for selecting a PLC bus from the plurality of buses based on the first signal, means for communicating a second signal to the selected PLC bus, the second signal based on the first signal, and means for filtering the second signal communicated to the selected PLC bus to prevent the second signal from passing through the main circuit breaker. The aforementioned means may be one or more of the aforementioned modules/components of the network 200 configured to perform the functions recited by the aforementioned means.

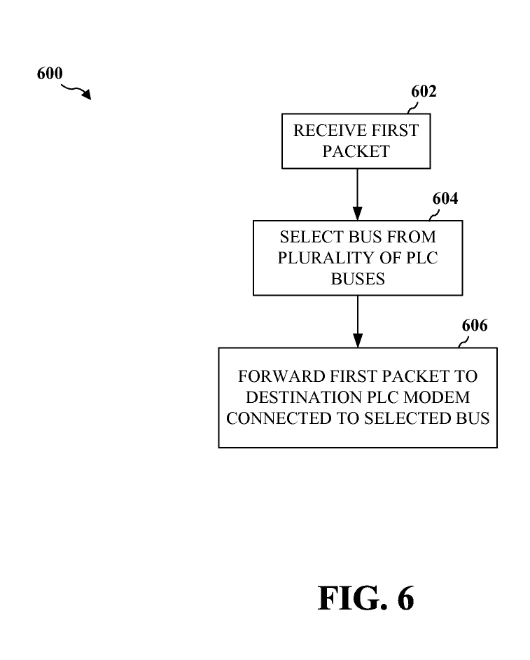

FIG. 6 is a flow chart 600 of a method of power line communication (PLC). The method may be performed by a switch (e.g., switch 230 of FIG. 2 or switch 322 of FIG. 3). At step 602, the switch receives a first packet. At step 604, the switch selects a bus from a plurality of PLC buses. The selected bus may include a plurality of connected PLC modems communicating with each other. The first packet may be received from the Internet. Alternatively, the first packet may be received from one of the plurality of buses other than the selected bus.

In an aspect, each of the PLC buses of the plurality of PLC buses may be connected to a main circuit breaker providing power. Furthermore, each PLC bus may be isolated from other buses of the plurality of buses. For example, the plurality of PLC buses may be isolated from each other with respect to PLC communication, but may not be isolated from each other with respect to power distribution.

In a further aspect, the switch selects a bus based on an address portion of the first packet. The address portion may correspond to a destination PLC modem that is one of a plurality of PLC modems connected to the selected bus.

At step 606, the switch forwards the first packet to a destination PLC modem connected to the selected bus. The first packet may then be forwarded from the destination PLC modem to a device via an Ethernet connection or Layer 2 signaling.

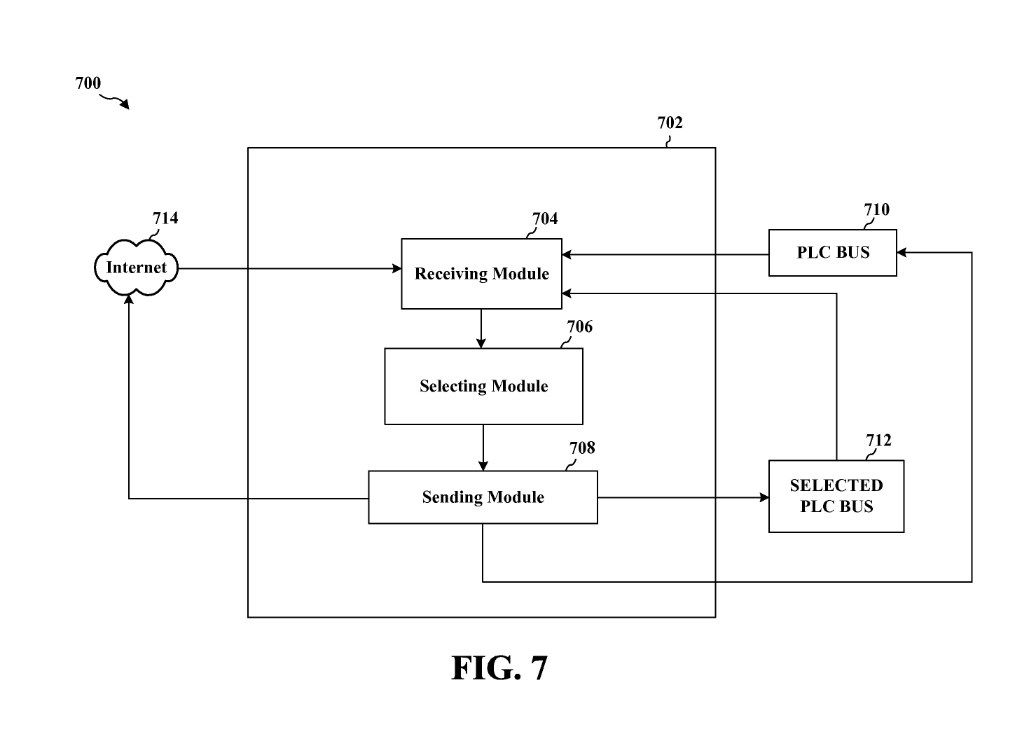

FIG. 7 is a conceptual data flow diagram 700 illustrating the data flow between different modules/means/components in an exemplary apparatus 702. The apparatus may be a switch (e.g., switch 230 of FIG. 2 or switch 322 of FIG. 3). The apparatus includes a receiving module 704, a selecting module 706, and a sending module 708.

The receiving module 704 receives a first packet. The selecting module 706 selects a bus (e.g., selected bus 712) from a plurality of PLC buses. The selected bus 712 may include a plurality of connected PLC modems communicating with each other. The first packet may be received from the Internet 714. Alternatively, the first packet may be received from one of the plurality of buses other than the selected bus (e.g., PLC bus 710).

In an aspect, each of the PLC buses of the plurality of PLC buses may be connected to a main circuit breaker providing power. Furthermore, each PLC bus may be isolated from other buses of the plurality of buses. For example, the plurality of PLC buses may be isolated from each other with respect to PLC communication, but may not be isolated from each other with respect to power distribution.

In a further aspect, the selecting module 706 selects a bus based on an address portion of the first packet. The address portion may correspond to a destination PLC modem that is one of a plurality of PLC modems connected to the selected bus 712.

The sending module 708 forwards the first packet to a destination PLC modem connected to the selected bus 712. The first packet may then be forwarded from the destination PLC modem to a device via an Ethernet connection or Layer 2 signaling.

The apparatus 702 may include additional modules that perform each of the steps of the algorithm in the aforementioned flow chart of FIG. 6. As such, each step in the aforementioned flow chart of FIG. 6 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

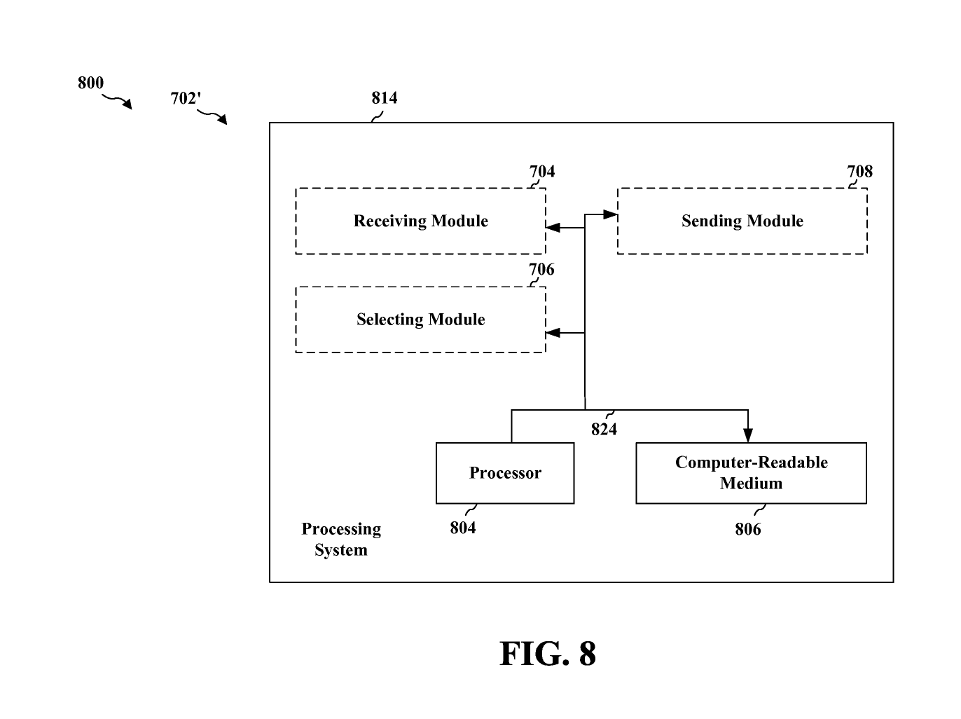

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 804, the modules 704, 706, 708, and the computer-readable medium 806. The bus 824 may also link various other circuits such as timing sources, peripherals, voltage regulators, and power management circuits, which are well known in the art, and therefore, will not be described any further.

The processing system 814 includes a processor 804 coupled to a computer-readable medium 806. The processor 804 is responsible for general processing, including the execution of software stored on the computer-readable medium 806. The software, when executed by the processor 804, causes the processing system 814 to perform the various functions described supra for any particular apparatus. The computer-readable medium 806 may also be used for storing data that is manipulated by the processor 804 when executing software. The processing system further includes at least one of the modules 704, 706, and 708. The modules may be software modules running in the processor 804, resident/stored in the computer readable medium 806, one or more hardware modules coupled to the processor 804, or some combination thereof. The processing system 814 may be a component of the switch 230 (FIG. 2) or the switch 322 (FIG. 3).

In one configuration, the apparatus 702/702′ for power line communication includes means for receiving a first packet, means for selecting a bus from a plurality of PLC buses, each PLC bus being isolated from other buses of the plurality of buses, and means for forwarding the first packet to a destination PLC modem connected to the selected bus. The aforementioned means may be one or more of the aforementioned modules of the apparatus 702 and/or the processing system 814 of the apparatus 702′ configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of power line communication (PLC), comprising:
receiving a first packet;
selecting a bus from a plurality of PLC buses, each PLC bus being isolated from other buses of the plurality of buses; and
forwarding the first packet to a destination PLC modem connected to the selected bus.

2. The method of claim 1, wherein each of the PLC buses of the plurality of PLC buses is connected to a main circuit breaker.

3. The method of claim 1, wherein the first packet is received from the Internet.

4. The method of claim 1, wherein the first packet is received from one of the plurality of buses other than the selected bus.

5. The method of claim 1, wherein the selecting comprises selecting based on an address portion of the first packet.

6. The method of claim 5, wherein the address portion corresponds to the destination PLC modem, the destination PLC modem being one of a plurality of PLC modems connected to the selected bus.

7. The method of claim 1, wherein the plurality of PLC buses are isolated from each other with respect to PLC communication, and wherein the plurality of PLC buses are not isolated from each other with respect to power distribution.

8. The method of claim 7, wherein the plurality of PLC buses are connected to a same main circuit breaker.

9. The method of claim 1, wherein the selected bus comprises a plurality of connected PLC modems communicating with each other.

10. An apparatus for power line communication (PLC), comprising:
means for receiving a first packet;
means for selecting a bus from a plurality of PLC buses, each PLC bus being isolated from other buses of the plurality of buses; and
means for forwarding the first packet to a destination PLC modem connected to the selected bus.

11. The apparatus of claim 10, wherein each of the PLC buses of the plurality of PLC buses is connected to a main circuit breaker.

12. The apparatus of claim 10, wherein the first packet is received from the Internet.

13. The apparatus of claim 10, wherein the first packet is received from one of the plurality of buses other than the selected bus.

14. The apparatus of claim 10, wherein the means for selecting is configured to select based on an address portion of the first packet.

15. The apparatus of claim 14, wherein the address portion corresponds to the destination PLC modem, the destination PLC modem being one of a plurality of PLC modems connected to the selected bus.

16. The apparatus of claim 10, wherein the plurality of PLC buses are isolated from each other with respect to PLC communication, and wherein the plurality of PLC buses are not isolated from each other with respect to power distribution.

17. The apparatus of claim 16, wherein the plurality of PLC buses are connected to a same main circuit breaker.

18. The apparatus of claim 10, wherein the selected bus comprises a plurality of connected PLC modems communicating with each other.

19. An apparatus for power line communication (PLC), comprising:
at least one processing system configured to:
receive a first packet;
select a bus from a plurality of PLC buses, each PLC bus being isolated from other buses of the plurality of buses; and
forward the first packet to a destination PLC modem connected to the selected bus.

20. The apparatus of claim 19, wherein each of the PLC buses of the plurality of PLC buses is connected to a main circuit breaker.

21. The apparatus of claim 19, wherein the first packet is received from the Internet.

22. The apparatus of claim 19, wherein the first packet is received from one of the plurality of buses other than the selected bus.

23. The apparatus of claim 19, wherein the at least one processing system is configured to select based on an address portion of the first packet.

24. The apparatus of claim 23, wherein the address portion corresponds to the destination PLC modem, the destination PLC modem being one of a plurality of PLC modems connected to the selected bus.

25. The apparatus of claim 19, wherein the plurality of PLC buses are isolated from each other with respect to PLC communication, and wherein the plurality of PLC buses are not isolated from each other with respect to power distribution.

26. The apparatus of claim 25, wherein the plurality of PLC buses are connected to a same main circuit breaker.

27. The apparatus of claim 19, wherein the selected bus comprises a plurality of connected PLC modems communicating with each other.

28. A computer program product for power line communication (PLC), comprising:
a computer-readable medium comprising code for:
receiving a first packet;
selecting a bus from a plurality of PLC buses, each PLC bus being isolated from other buses of the plurality of buses; and
forwarding the first packet to a destination PLC modem connected to the selected bus.

29. The computer program product of claim 28, wherein each of the PLC buses of the plurality of PLC buses is connected to a main circuit breaker.

30. The computer program product of claim 28, wherein the first packet is received from the Internet.

31. The computer program product of claim 28, wherein the first packet is received from one of the plurality of buses other than the selected bus.

32. The computer program product of claim 28, wherein the code for selecting is configured to select based on an address portion of the first packet.

33. The computer program product of claim 32, wherein the address portion corresponds to the destination PLC modem, the destination PLC modem being one of a plurality of PLC modems connected to the selected bus.

34. The computer program product of claim 28, wherein the plurality of PLC buses are isolated from each other with respect to PLC communication, and wherein the plurality of PLC buses are not isolated from each other with respect to power distribution.

35. The computer program product of claim 34, wherein the plurality of PLC buses are connected to a same main circuit breaker.

36. The computer program product of claim 28, wherein the selected bus comprises a plurality of connected PLC modems communicating with each other.

37. A switched power line communication (PLC) network, comprising:
a plurality of PLC buses, each PLC bus isolated from other buses of the plurality of buses;
a main circuit breaker for providing power to the plurality of PLC buses;
a switch for receiving a first signal for communicating to a PLC bus, selecting a PLC bus from the plurality of PLC buses based on the first signal, and communicating a second signal to the selected PLC bus, the second signal based on the first signal; and
a plurality of filters for filtering a signal communicated on a PLC bus to prevent the communicated signal from passing through the main circuit breaker, wherein a respective filter of the plurality of filters is connected between a corresponding PLC bus and the main circuit breaker, and wherein the respective filter is connected between the switch and the main circuit breaker.

38. The switched PLC network of claim 37, wherein the plurality of PLC buses are isolated from each other with respect to PLC communication, and wherein the plurality of PLC buses are not isolated from each other with respect to power distribution.

39. The switched PLC network of claim 37, wherein each PLC bus comprises a plurality of connected PLC modems communicating with each other.

40. The switched PLC network of claim 37, further comprising:
at least one PLC modem connected to an electric outlet of one of the PLC buses; and
at least one other PLC modem connected to an electric outlet of another one of the PLC buses,
wherein the at least one PLC modem communicates a signal with the at least one other PLC modem via the switch.

41. The switched PLC network of claim 37, wherein the switch communicates the second signal to a destination PLC modem connected to the selected bus.

42. The switched PLC network of claim 37, wherein the switch receives the first signal from the Internet.

43. The switched PLC network of claim 37, wherein the switch receives the first signal from one of the plurality of buses other than the selected bus.

44. A method for switched power line communication (PLC), comprising:
providing power to a plurality of PLC buses via a main circuit breaker, each PLC bus isolated from other buses of the plurality of buses;
receiving a first signal for communicating to a PLC bus;
selecting a PLC bus from the plurality of buses based on the first signal;
communicating a second signal to the selected PLC bus, the second signal based on the first signal; and
filtering the second signal communicated to the selected PLC bus to prevent the second signal from passing through the main circuit breaker.

45. The method of claim 44, wherein the plurality of PLC buses are isolated from each other with respect to PLC communication, and wherein the plurality of PLC buses are not isolated from each other with respect to power distribution.

46. The method of claim 44, wherein each PLC bus comprises a plurality of connected PLC modems communicating with each other.

47. The method of claim 44, wherein the second signal is communicated to a destination PLC modem connected to the selected bus.

48. The method of claim 44, wherein the first signal is received from the Internet.

49. The method of claim 44, wherein the first signal is received from one of the plurality of buses other than the selected bus.

50. The method of claim 49, further comprising filtering the first signal to prevent the first signal from passing through the main circuit breaker.

51. A system for switched power line communication (PLC), comprising:
means for providing power to a plurality of PLC buses via a main circuit breaker, each PLC bus isolated from other buses of the plurality of buses;
means for receiving a first signal for communicating to a PLC bus;
means for selecting a PLC bus from the plurality of buses based on the first signal;
means for communicating a second signal to the selected PLC bus, the second signal based on the first signal; and
means for filtering the second signal communicated to the selected PLC bus to prevent the second signal from passing through the main circuit breaker.

52. The system of claim 51, wherein the plurality of PLC buses are isolated from each other with respect to PLC communication, and wherein the plurality of PLC buses are not isolated from each other with respect to power distribution.

53. The system of claim 51, wherein each PLC bus comprises a plurality of connected PLC modems communicating with each other.

54. The system of claim 51, wherein the second signal is communicated to a destination PLC modem connected to the selected bus.

55. The system of claim 51, wherein the first signal is received from the Internet.

56. The system of claim 51, wherein the first signal is received from one of the plurality of buses other than the selected bus.

57. The system of claim 56, wherein the means for filtering is configured to filter the first signal to prevent the first signal from passing through the main circuit breaker.
